(19) United States
(12) Patent Application Publication
(10) Pub. No.: US 2026/0051522 A1
(43) Pub. Date: Feb. 19, 2026

(54) SYSTEM AND METHOD FOR PREDICTING EXIT FROM A VOLTAGE SUPPRESSION CONTROL IN A FUEL CELL ELECTRIC VEHICLE

(71) Applicant: Ford Global Technologies, LLC, Dearborn, MI (US)

(72) Inventors: Craig Michael Mathie, White Lake Twp., MI (US); Matthew Riley, Ann Arbor, MI (US)

(21) Appl. No.: 18/804,938

(22) Filed: Aug. 14, 2024

(51) Int. Cl. H01M 8/04858; B60L 58/30; H01M 8/04089; H01M 8/043; H01M 8/04313; H01M 8/04746

(52) U.S. Cl. CPC H01M 8/0494; H01M 8/04089; H01M 8/043; H01M 8/04313; H01M 8/04753; B60L 58/30; H01M 2250/20

(57) ABSTRACT

A vehicle system for fuel cell electric vehicle (FCEV) includes a fuel cell system including a fuel cell stack, and one or more controllers configured to inject reactants to the fuel cell stack exiting a power conservation control of the fuel cell system prior to actuation of an accelerator in response to a drive intent operation to a vehicle component from among a plurality of vehicle components.

### STATEMENT REGARDING FEDERALLY SPONSORED RESEARCH OR DEVELOPMENT

This invention was made with Government support under Contract No. DE-EE0009858 awarded by the U.S. Department of Energy. The Government has certain rights in the invention.

### TECHNICAL FIELD

The present disclosure generally relates to a system or method for controlling power generated by a fuel cell system of a fuel cell electric vehicle (FCEV).

### BACKGROUND

A fuel cell electric vehicle (FCEV) includes one or more fuel cell stacks that provide electrical power for propelling the FCEV. The fuel cell stack is an electrochemical device that converts chemical energy of a fuel (e.g., hydrogen) and an oxidizing agent (e.g., oxygen) into electrical energy, with water as a byproduct. In some application, an FCEV may further include a high voltage battery pack to provide electrical power to propel the FCEV separately or in combination with the fuel cell stacks.

At times when the FCEV is parked and idle, the FCEV can operate in a voltage suppression control to inhibit or curb the electrochemical reaction and constrain degradation of the fuel cell stack.

### SUMMARY

In one form, the present disclosure is directed to a vehicle system for fuel cell electric vehicle (FCEV). The vehicle system includes a fuel cell system and one or more controllers. The fuel cell system includes a fuel cell stack. The one or more controllers are configured to inject reactants to the fuel cell stack prior to actuation of an accelerator in response to a drive intent operation to a vehicle component from among a plurality of vehicle components

In one form, the present disclosure is directed to a method for controlling a fuel cell electric vehicle (FCEV) having a fuel cell system. The method includes closing an injection valve to inhibit injection of reactants to a fuel cell stack of the fuel cell system for a power conservation control, and opening the injection valve to inject reactants to the fuel cell stack prior to actuation of an accelerator in response to a drive intent operation to a vehicle component from among a plurality of vehicle components.

In one form, the present disclosure is directed to a vehicle control system for a fuel cell electric vehicle (FCEV) having a fuel cell system. The vehicle control system includes a processor and a non-transitory computer-readable storage medium comprising programming instructions that are configured to cause the processor to implement a method for controlling the FCEV, wherein the programming instructions comprise instructions to: close an injection valve to inhibit injection of reactants to a fuel cell stack of the fuel cell system for a power conservation control in response to detecting a park state and a park-idle intent operation to a vehicle component among a plurality of vehicle components, and open the injection valve to inject reactants to the fuel cell stack prior to actuation of an accelerator in response to a drive intent operation to a vehicle component from among the plurality of vehicle components. The park-idle intent operation includes at least one of: opening of a door panel, closure of a side-view mirror, extension of an interior foldable table, location of the FCEV being at a desired destination, or unfastening of a seatbelt. The drive intent operation includes at least one of actuation of a side-view mirror, fastening of a seatbelt, adjustment of a seat to a drive position, activation of route guidance application to a selected destination, or closure of an interior foldable table.

### BRIEF DESCRIPTION OF THE DRAWINGS

FIG. 1 illustrates an example fuel cell electric vehicle (FCEV);

FIG. 2 is an example block diagram of a fuel cell system; and

FIG. 3 is a flowchart of an example power conservation routine is provided.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

During some operations, a fuel cell system of a FCEV is operated in a voltage suppression mode when the FCEV is in park and power demand is low to improve durability or reduce wear of the fuel cell system. However, in the voltage suppression mode, water may accumulate in fluid passageways, because of low flow of reactant gases which typically remove the water. If the FCEV exits the park state and undergoes a high acceleration, the water can inhibit reactant flow, which can result in poor performance or shutdown of the fuel cell system. Some FCEVs may be configured to increase reactant flows at set intervals to periodically remove the water. However, when reactant gas flow increases, the fuel cell system can come out of the voltage suppression mode early. And if the power demand remains low, the voltage of the fuel cell system can rise to a level near open circuit voltage that can cause wear on the fuel cell system.

In one form, the present disclosure is directed to a system or method for controlling the FCEV to exit a power conservation control (e.g., a voltage suppression mode) by injecting fuel and/or air (e.g., reactants) to a fuel cell stack of the fuel cell system prior to actuation of an accelerator in response to a drive intent operation of a vehicle component of the FCEV. The drive intent operation are defined to be operation of a vehicle component that takes place prior to the FCEV being placed in a drive state or accelerated. In a non-limiting example, the drive intent operation may include at least one of actuation of a side-view mirror, fastening of a seatbelt, adjustment of a seat to a drive position, activation of route guidance application to a selected destination, or closure of an interior foldable table. By monitoring various vehicle component to detect the drive intent operation, the system is able to predict whether the FCEV is to be driven, and remove possible water accumulation prior to the acceleration of the FCEV.

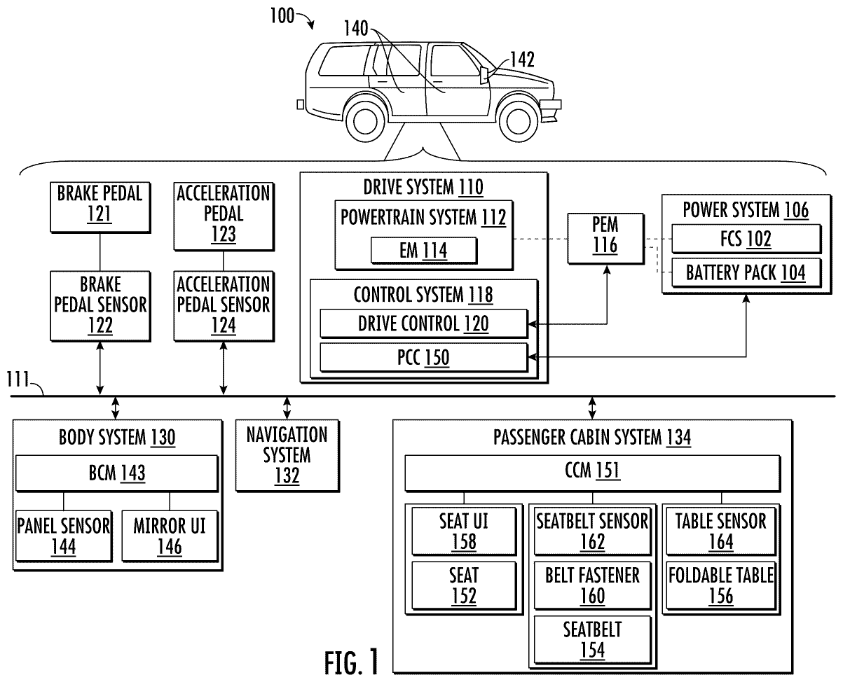

Referring to FIG. 1, an example fuel cell electric vehicle (FCEV) 100 includes a fuel cell system (FCS) 102 and a battery pack 104 (e.g., a traction battery) that form at least a portion of a power system 106 of the FCEV 100. The FCS 102 and the battery pack 104 are individually operable for providing electrical energy for propulsion of the FCEV 100 via a drive system 110. In one form, components/systems of the FCEV 100 may be in communication using a vehicle communication network 111 (e.g., wireless network or wired network such as controlled area network).

In one form, among other components, the drive system 110 includes a powertrain system 112 having one or more electric machines (EM) 114 capable of operating as a motor and as a generator. As a motor, the EM 114, which is mechanically connected to a transmission (not shown), provides propulsion and slowing capability for the FCEV 100. The EM 114 acting as a generator may recover energy that may normally be lost as heat in a friction braking system (not shown) to recharge the battery pack 104.

The FCS 102 includes one or more fuel cell stacks, where fuel cell stack includes a plurality of fuel cells electrically connected in series. As detailed herein, the FCS 102 converts hydrogen fuel into electrical energy that is used by the EM 114 for propelling the FCEV 100 and/or for recharging the battery pack 104. In FIG. 1, dashed lines represent power lines for high electric power and solid lines indicate control signals or data communication.

The FCS 102 and the battery pack 104 may be electrically connected to the EM 114 via a power electronics module (PEM) 116 that may include an inverter, direct current (DC)-to-DC converter, among other components. In one form, the PEM 116 is configured to transfer electrical energy from the FCS 102 to the EM 114. For example, the FCS 102 may provide direct current (DC) electrical energy while the EM 114 may require three-phase alternating current (AC) electrical energy to function. The PEM 116 may convert the electrical energy from the FCS 102 into electrical energy having a form compatible for operating the EM 114 or, in some applications, for charging the battery pack 104. In this way, the FCEV 100 may be configured to be propelled with use of electrical energy from the FCS 102.

The battery pack 104 stores electrical energy for use by the EM 114 for propelling the FCEV 100. The battery pack 104 may also be electrically connected to the EM 114 via the PEM 116. The PEM 116 may provide the ability to bi-directionally transfer electrical energy between the battery pack 104 and the EM 114. In this way, the FCEV 100 may be further configured to be propelled with the use of the battery pack 104 individually or in combination with the FCS 102. Furthermore, in a regenerative mode, the PEM 116 may convert AC electrical energy from the EM 114, acting as a generator, to DC electrical energy compatible with the battery pack 104.

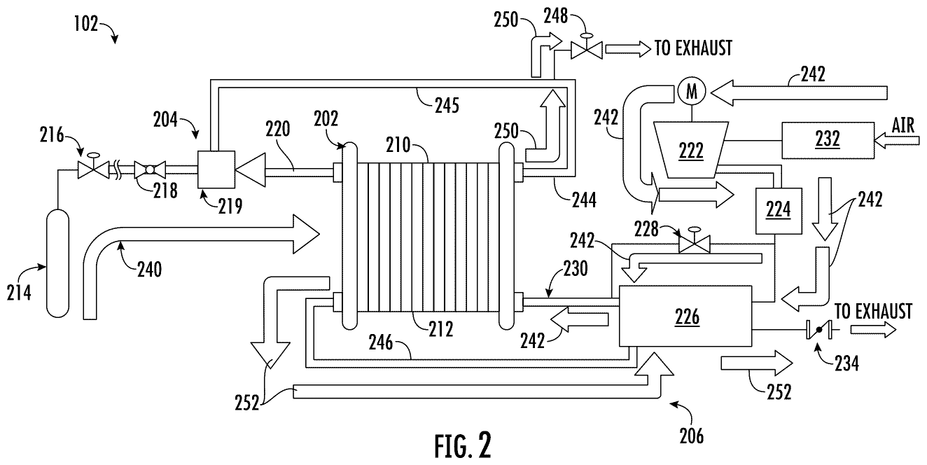

Referring to FIG. 2, an example FCS 102 includes a fuel cell stack 202, a hydrogen supply-return system (hydrogen SRS) 204 for supplying hydrogen fuel to an anode side of the fuel cell stack 202, and an air supply-return system (air SRS) 206 for supply air to a cathode side of the fuel cell stack 202. The fuel cell stack 202 includes multiple fuel cells arranged in series and having anode members to define the anode side 210 and cathode members to define the cathode side 212 with electrolyte section (not shown) arranged in the middle. While one fuel cell stack 202 is illustrated, for simplicity, the FCS 102 may include more than one fuel cell stack 202.

In one form, the hydrogen SRS 204 includes a hydrogen tank 214 for storing the hydrogen fuel, a control valve 216 (e.g., hydrogen pressure control valve) operable to control flow of fuel from the tank 214, and an injection valve 218 operable to supply the fuel towards the fuel cell stack 202. In some applications, an anode supply manifold 220 supplies the fuel via the injection valve 218 to the fuel cell stack 202. It should be readily understood that the hydrogen SRS 204 may include additional components, such as but not limited to sensors arranged at the tank 214 and along a fuel line fluidly coupling the tank 214 and the fuel cell stack 202 to measure fuel characteristics (temperature and/or pressure).

In one form, the air SRS 206 includes a compressor 222 for drawing and supplying air to the fuel stack 202 by way of an intercooler 224 to cool the air from the compressor 222. In some aspects, a humidifier 226 is provided to condition air provided to the fuel cell stack 202 and air being returned from fuel cell stack 202. A bypass valve 228 may be provided to bypass the humidifier 226 such that air from the intercooler 224 flows to the fuel cell stack 202. In other variations, the air is introduced via a cathode supply manifold 230. The air SRS 206 may include other components such as, but not limited to, an air filter 232 upstream of the compressor 222 and one or more sensors arranged between an inlet drawings air into the air SRS 206 and the cathode supply manifold 230 (e.g., temperature sensor and/or pressure sensor).

In operation, hydrogen is injected into the anode side 210 via the injection valve 218 and air is injected to the cathode side 212 causing hydrogen molecules to split into electrons and protons. The protons pass through the electrolyte section and the electrons flow through a circuit generating an electric current and heat. At the cathode side 212, the protons, electrons, and oxygen combine forming water byproduct. Arrow 240 provides an example flow of fuel to the fuel cell stack 202 along the hydrogen SRS 204 and arrows 242 provide an example flow of air to the fuel cell stack 202 along the air SRS 206.

From the fuel cell stack 202, the by product from the anode side 210 is directed out of the fuel cell stack 202 to an exhaust via a return manifold 244 and a purge valve 248. Some of the byproduct from the anode side 210 is directed towards the anode supply manifold 220, via a recirculation line 245. The recirculation may be driven by a recirculation blower (not shown) or by an ejector 219. In addition to the byproduct, the return manifold 244 is further configured to remove residual gases and water provided at the return manifold 244. The flow of byproduct/extra hydrogen along the hydrogen SRS 204 to the exhaust is illustrated by arrow 250.

From the fuel cell stack 202, the by product from the cathode side 212 is directed to an exhaust via a return manifold 246. In addition to the return manifold 246, the air SRS 206 may also include an electronic throttle body 234. The flow of the byproduct/air of the air SRS 206 is illustrated by arrows 252.

As noted above, the fuel cell stack 202 includes a series connection of a plurality of fuel cells. The voltage of each fuel cell may depend on various factors including, but not limited to, cell temperature, membrane humidity, pressure, anode hydrogen amount, air flow rate, and/or electric current generated. In a non-limiting example, the voltage of the fuel cell stack 202 may be a summation of all the voltages of the fuel cells. Likewise, each fuel cell may have the same current, and the electric current of the fuel cell stack 202 may be inferred as the same as the current of each fuel cell. Accordingly, the power provided by the fuel cell stack 202 may be equal to the voltage of fuel cell stack 202 multiplied by the current of the fuel cell stack.

With continuing reference to FIG. 1, in one form, the drive system 110 includes a control system 118 having one or more controllers to control and monitor the operation of the FCS 102 and the battery pack 104. In a non-limiting example, the control system 118 is configured to include a drive control 120 to determine a drive demand based on, for example, state of charge of the battery pack 104, voltage and current of the FCS 102, position of a brake pedal 121 detected by a brake pedal sensor 122, and/or a position of an acceleration pedal 123 detected by an acceleration pedal sensor 124. Using stored algorithms, the control system 118 determines the amount of power needed to meet a drive demand and controls the FCS 102 and/or the battery pack 104 to generate the required power. In a non-limiting example, the control system 118 draws power from the FCS 102, the battery pack 104, or both the FCS 102 and the battery pack 104.

At times, the FCEV 100 may be in a park state, not requiring power to move the FCEV 100. During this time, the control system 118 may perform a power conservation control (PCC) 150 to have the FCS 102 generate little to no power. That is, with the PCC 150, the control system 118 may inhibit hydrogen and/or air from being injected in the fuel cell stack 202 by controlling the state of the valves 216. The PCC 150, which may also be referred to as a voltage suppression mode, can preserve life of the fuel cell stack 202. In the following and in the claims, the term “reactants” may be used to refer to hydrogen, air, or both.

In determining when to exit the PCC 150, the control system 118 is configured to detect a drive intent operation to a vehicle component, where the drive intent operation generally occurs before the actuation of the acceleration pedal 123, which may also be referred to as an accelerator. In a non-limiting example, the drive intent operation includes at least one of: actuation of a side-view mirror, connection of a seatbelt, adjustment of a seat to a drive ready position, activation of a route guidance application to a selected destination, or closure of an interior table. The drive intent operation may be detected by various components/systems, such as but not limited to a body system 130, a navigation system 132, and a passenger cabin system 134.

In the following, while specific examples are provided for monitoring state of vehicle components and/or detecting a drive intent operation, other suitable techniques and./or vehicle components may be used. In a non-limiting example, if the FCEV 100 is equipped with a driver attention detector that employs a vision system for monitoring driver drowsiness or attention, the driver attention detector can be employed to detect a drive intent operation. For instance, a drive intent operation may include the driver's gaze being detected as focused and on the road after detecting the driver's gaze as being absent or unfocused. In yet another example, a steering wheel of the FCEV 100 may be equipped with touch sensors to detect the hands of the driver, and a driver intent operation may include the detection of at least one hand on steering wheel indicating the intent of the driver to operate the FCEV 100.

In some forms, the control system 118 is configured to exit the PCC 150 when one drive intent operation is detected or a combination of drive intent operations are detected. For example, a drive intent operation may be detected once the seatbelt is fastened or when the driver seat is in a drive position and the navigation system is provided a destination.

In one form, the body system 130 is configured to detect and/or control position of various exterior components of the FCEV, such as but not limited to one or more door panels 140 and/or one or more side mirrors 142, and may include a body control module (BCM) 143 to detect and/or control position of exterior components. Prior to driving, a passenger may close one or more door panels 140 to the FCEV 100, where the door panel 140 may include, but is not limited to, a trunk, a passenger door to enter a cabin, and/or a hood. In a nonlimiting example, the drive intent operation is indicative of a closure of the door panel 140, and the body system 130 employs a panel sensor 144 (e.g., position sensor) provided at the door panel 140 to detect whether the door panel 140 is open or closed.

In some aspects, prior to driving, the passenger may adjust the side view mirrors 142 using a mirror user interface (UI) 146 generally provided in the passenger cabin (e.g., buttons provided near a driver seat). In a non-limiting example, the BCM 143 detects position of the side view mirror 142 by defining a nominal position or coordinate of the mirror 142 and tracks a present position of the mirror 142 based on movement of the mirror 142 caused by a motor attached to the mirror 142 in response to operation of the mirror UI 146. The BCM 143 may also track a position of the mirror 142 using a type of position sensor. In one form, the position of the mirror 142 maybe used as a drive intent operation in response to the position being within a drive view position range, which is defined as a range of positions the side-view mirror may be provided when the FCEV 100 is to be driven. In a non-limiting example, the position may be provided as an angle and/or identified in a multi-dimensional space.

In another variation, in addition to or in lieu of a position/angle of the mirror 142, the drive intent operation may be detected when the side view mirror moves from a folded state to an extended state, which may be controlled by the BCM 143. That is, some BCM 143 may fold the mirror 142 toward the door panel 140, when, for example, the FCEV 100 is turned-off, locked, or in response a defined button part of the mirror UI 146 being operated. Actuation or movement of the mirror 142 from being folded to being extended may indicate that the FCEV 100 is to be placed in the drive state.

The navigation system 132 is configured to define a route to a desired destination that is entered by a passenger. In a non-limiting example, the navigation system 132 may be built into the FCEV 100 where dedicated navigation user interfaces (e.g., buttons, navigation graphical user interfaced displayed on a touchscreen) is used to enter the destination. In another example, in lieu of or in addition to a separate dedicated navigation, the navigation system 132 is supported by a software app on a portable computing device (e.g., smart phone) in communication with the FCEV 100. In one form, the entry of a desired destination indicates that the FCEV 100 is to move to a drive state, and thus, may be used to indicate a drive intent operation.

The passenger cabin system 134 is configured to detect actuation of one or more vehicle components provided in a passenger cabin and includes a cabin control module (CCM) 151. In a non-limiting example, the vehicle component may include passenger seat 152, a seatbelt 154, and/or a foldable table 156.

In one form, the seat 152 is equipped with an electric motor (not shown) to move the seat 152 in one or more positional directions using a seat user interface (UI) 158. Positional movement of the seat 152 may adjust a vertical position (height of seat), an incline of a seat-back (e.g., seat back angle adjustment), and/or a horizontal position to adjust how close the seat 152 is to a steering wheel. In a non-limiting example, the CCM 151 is able to detect a position of, at least, a driver seat based on, for example, data from sensors and/or movement of the seat 152 from a zero position.

In some variations, the CCM 151 is configured to store positional information of desired seat position for a user, and control the electric motor to place the seat 152 in the desired position in response to a defined seat UI 158 associated with the stored positional information is operated. Accordingly, a drive intent operation may be detected if a passenger in the driver seat operates the button defining his/her desired seat position (e.g., a drive position). In another variation, prior to driving, the position of the driver seat 152 is generally upright, and the CCM 151 is configured to detect when the seat 152 goes from flat to upright (e.g., a drive position) indicating a drive intent operation.

In one form, the CCM 151 is configured to detect whether the seatbelt 154 is connected to a belt fastener 160 using, for example, a seatbelt sensor 162 or other suitable known techniques. If the seat belt is disconnected once parked and is then connected, the CCM 151 detects such alteration, which may be employed for indicating a drive intent operation.

In the event, the FCEV 100 includes the foldable table 156, the CCM 151 is configured to detect whether the table 156 is extended or stowed away using a table position sensor 164 provided at, for example, storage compartment of the table 156. A drive intent operation may be indicated if the table 156 is extended once parked and is then stowed away.

In some aspects, with the FCEV 100 under drive control, the control system 118 is configured to detect if the FCEV 100 should enter the PCC 150 based on one or more park-idle intent operation to a vehicle component. For example, using the body system 130, the navigation system 132 and/or the passenger cabin system 134, the control system 118 is configured to enter the PCC 150 to inhibit injection of reactants to the fuel cell stack 202 in response to detecting a park state of the FCEV 100 and a park-idle intent operation to the vehicle component among the plurality of vehicle components. The park-idle intent operation includes at least one of: opening of the door panel 140, closure of a side-view mirror 142, extension of the foldable table 156, location of the FCEV 100 being at the desired destination; or disconnecting the seatbelt from the belt fastener of the seatbelt.

In addition to the vehicle being parked and in addition to or in lieu of the detection of the park-idle intent operation, the control system 118 is further configured to enter the PCC 150 in response to a state of charge (SOC) of the battery pack 104 being greater than or equal to a SOC threshold. That is, the PCC 150 would not start until the battery pack 104 is sufficiently charged as defined by the SOC threshold (e.g., 50%, 45%, 60%).

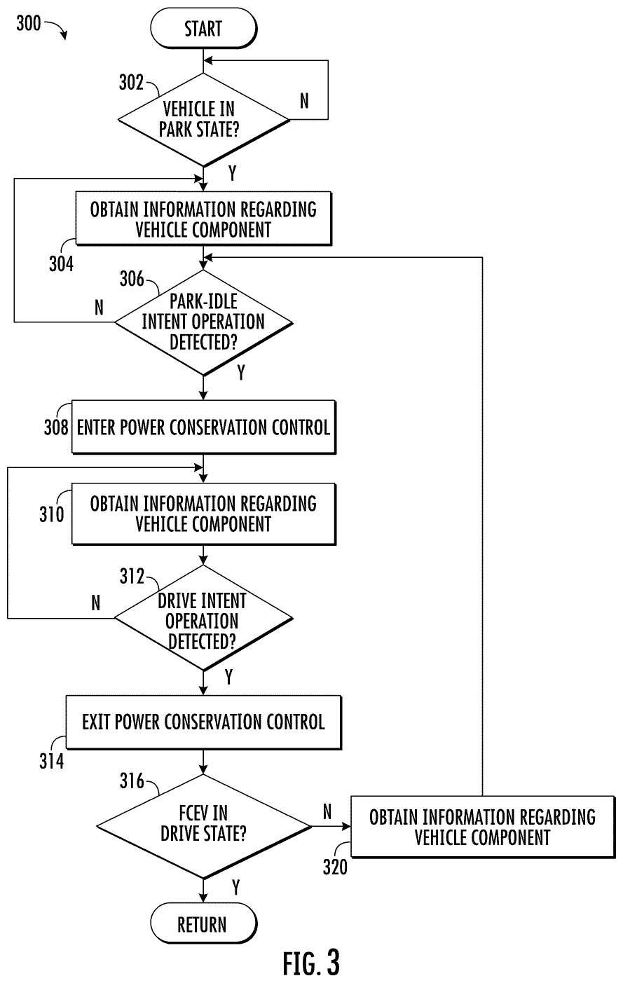

Referring to FIG. 3, an example power conservation routine 300, which is performed by the control system 118 when the FCEV 100 is turned ON. At operation 302, the system 118 determine if the FCEV 100 is in the park state based on, for example, a position or operation of shift gear (not shown).

At operation 304 the system 118 obtains information regarding vehicle components using the vehicle communication network 111. In a non-limiting example, the information may include a state of seatbelt 154 (fastened or unfastened), position of a driver seat 152, position of the side-view mirror 142, position of the foldable table 156, or destination information.

At operation 306, the system 118 determines if a park-idle intent operation of at least one component is detected. In a non-limiting example, the park-idle intent operation includes at least one of: opening of the door panel 140, closure of the side-view mirror 142, extension of the foldable table 156, location of the FCEV being at a desired destination, or unfastening of the seatbelt 154.

If at least one park-idle intent operation is detected, the system 118 enters the power conservation control at operation 308 to limit or inhibit power production of the FCS 102.

At operation 310, the system 118 obtains information regarding one or more vehicle component, and at operation 312 determines if a drive intent operation is detected with respect to one or more vehicle component. That is, the system 118 determines if a state of a vehicle component has changed using the previous and latest information obtained. As detailed above, the drive intent operation may include, but is not limited to, at least one of actuation of a side-view mirror, fastening of a seatbelt, adjustment of a seat to a drive position, activation of route guidance application to a selected destination, or closure of an interior foldable table.

At operation 314, the system 118 exits the PCC 150 to enter drive control in response to detecting the drive intent operation. That is, the system 118 anticipates that the FCEV 100 is to begin driving based on the change in state of one or more vehicle component that generally occurs prior to the acceleration pedal 123 being pressed. In one form, prior to actuation of the acceleration pedal 123, the system 118 controls valves of the FCS 102 to inject reactants into the fuel cell stack 202 to remove possible water accumulation.

At operation 316, the system 118 determines if the FCEV 100 is in a drive state. That is, the system 118 confirms whether the FCEV 100 actually enters the drive state by, for example, detecting a gear shift being placed in drive and/or actuation of the acceleration pedal 123. If the drive state is detected, the system 118 returns to 302.

If the FCEV 100 is not in the drive state, the system 118 obtains information regarding the vehicle component(s), at operation 320, and returns to operation 306 to determine if the park-idle intent operation is detected.

Routine 300 is just one example, and the power conservation routine 300 may be configured in other suitable ways. In a non-limiting example, in addition to or in lieu of employing the park-idle intent operation detection, the system 118 is configured to enter the PCC 150 once, the FCEV 100 in the park state and is ON for a predetermined time period (e.g., 45 seconds, 2-mins). In another variation, the system 118 may confirm that the SOC of the battery pack 104 is greater than or equal to the charge threshold prior to entering the PCC 150.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a USB, CD, a DVD, or a Blu-ray Disc).

The apparatuses and methods described in this application may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle system for fuel cell electric vehicle (FCEV), comprising:
a fuel cell system including a fuel cell stack; and
one or more controllers configured to inject reactants to the fuel cell stack exiting a power conservation control of the fuel cell system prior to actuation of an accelerator in response to a drive intent operation to a vehicle component from among a plurality of vehicle components.

2. The vehicle system of claim 1, wherein the drive intent operation includes at least one of actuation of a side-view mirror, fastening of a seatbelt, adjustment of a seat to a drive position, activation of route guidance application to a selected destination, or closure of an interior foldable table.

3. The vehicle system of claim 1, further comprising one or more sensors configured to detect position of a door panel, wherein the drive intent operation is indicative of a closure of the door panel in response to the one or more sensors indicating the door panel is closed.

4. The vehicle system of claim 1, wherein:
the plurality of vehicle components includes a seat, and
the one or more controllers is configured to detect a position of the seat and the drive intent operation is indicative of the position of the seat being in a drive position.

5. The vehicle system of claim 1, wherein:
the plurality of vehicle components includes a side-view mirror, and
the one or more controllers is configured to detect a position of the side-view mirror and the drive intent operation is indicative of the position of the side-view mirror being at least one of extended or having a position within or at a drive view position range.

6. The vehicle system of claim 1, wherein the one or more controllers is further configured to inhibit injection of reactants to the fuel cell stack to enter the power conservation control in response to detecting a park state and a park-idle intent operation to the vehicle component among the plurality of vehicle components.

7. The vehicle system of claim 6, wherein the park-idle intent operation includes at least one of: opening of a door panel, closure of a side-view mirror, extension of an interior foldable table, location of the FCEV being at a desired destination, or unfastening of a seatbelt.

8. The vehicle system of claim 1, further comprising a battery pack, wherein the one or more controllers is further configured to inhibit injection of the reactants to the fuel cell stack to enter the power conservation control in response to a state of charge (SOC) of the battery pack being greater than or equal to a SOC threshold.

9. The vehicle system of claim 8, wherein the one or more controllers is configured to inject reactants to the fuel cell stack exiting the power conservation control of the fuel cell system to charge the battery pack using electric power from the fuel cell system in response to the SOC of the battery pack being less than the SOC threshold.

10. The vehicle system of claim 1, further comprising an electric machine operable to provide propulsion power using electric power from the fuel cell system.

11. A method for controlling a fuel cell electric vehicle (FCEV) having a fuel cell system, comprising:
closing an injection valve to inhibit injection of reactants to a fuel cell stack of the fuel cell system for a power conservation control; and
opening the injection valve to inject reactants to the fuel cell stack prior to actuation of an accelerator in response to a drive intent operation to a vehicle component from among a plurality of vehicle components.

12. The method of claim 11, wherein the drive intent operation includes at least one of actuation of a side-view mirror, fastening of a seatbelt, adjustment of a seat to a drive position, activation of route guidance application to a selected destination, or closure of an interior foldable table.

13. The method of claim 11, further comprising detecting the drive intent operation as a position of a door panel being in a closed position after being in an open position.

14. The method of claim 11, wherein:
the plurality of vehicle components includes a seat, and
the method further includes detecting the drive intent operation as a position of the seat being adjusted to a drive position.

15. The method of claim 11, wherein:
the plurality of vehicle components includes a side-view mirror, and
the method further includes detecting the drive intent operation as a position of the side-view mirror being at least one of extended after being folded or having a position within or at a drive view position range.

16. The method of claim 11, wherein the injection valve is closed to inhibit injection of reactants for the power conservation control in response to detecting a park state and a park-idle intent operation to the vehicle component among the plurality of vehicle components.

17. The method of claim 16, wherein the park-idle intent operation includes at least one of: opening of a door panel, closure of a side-view mirror, extension of an interior foldable table, location of the FCEV being at a desired destination, or unfastening of a seatbelt.

18. The method of claim 11, further comprising inhibiting injection of the reactants to the fuel cell stack to enter the power conservation control in response to a state of charge (SOC) of a battery pack being greater than or equal to a SOC threshold.

19. The method of claim 18, further comprising injecting reactants to the fuel cell stack to charge the battery pack using electric power from the fuel cell system in response to the SOC of the battery pack being less than the SOC threshold.

20. A vehicle control system for a fuel cell electric vehicle (FCEV) having a fuel cell system, comprising:
a processor; and
a non-transitory computer-readable storage medium comprising programming instructions that are configured to cause the processor to implement a method for controlling the FCEV, wherein the programming instructions comprise instructions to:
close an injection valve to inhibit injection of reactants to a fuel cell stack of the fuel cell system for a power conservation control in response to detecting a park state and a park-idle intent operation to a vehicle component among a plurality of vehicle components, and
open the injection valve to inject reactants to the fuel cell stack prior to actuation of an accelerator in response to a drive intent operation to a vehicle component from among the plurality of vehicle components, wherein:
the park-idle intent operation includes at least one of: opening of a door panel, closure of a side-view mirror, extension of an interior foldable table, location of the FCEV being at a desired destination, or unfastening of a seatbelt, and
the drive intent operation includes at least one of actuation of a side-view mirror, fastening of a seatbelt, adjustment of a seat to a drive position, activation of route guidance application to a selected destination, or closure of an interior foldable table.
